(19) United States
(12) Patent Application Publication
(10) Pub. No.: US 2017/0225540 A1
(43) Pub. Date: Aug. 10, 2017

(54) AIR CONDITIONER FOR VEHICLE

(71) Applicant: DENSO CORPORATION, Kariya-city, Aichi-pref. (JP)

(72) Inventor: Dai ITO, Kariya-city (JP)

(21) Appl. No.: 15/515,550

(22) PCT Filed: Dec. 11, 2015
(86) PCT No.: PCT/JP2015/006195

§ 371 Date: Mar. 29, 2017

(30) Foreign Application Priority Data
Dec. 18, 2014 (JP) 2014-256566

(51) Int. Cl. B60H 1/00; B60H 1/22

(52) U.S. Cl. CPC B60H 1/00778; B60H 1/00735; B60H 1/22; B60H 1/00

(57) ABSTRACT

An air conditioner for a vehicle includes a pre-air conditioning control unit capable of setting a pre-blowing operation mode and a pre-air conditioning operation mode. In the pre-blowing operation mode, a blower is operated with an operation of a compressor prohibited, while an introduction mode is set at an outside-air introduction mode with an output from the blower maximized, and further a blowing mode is set at a face-foot mode. In the pre-air conditioning operation mode, the blower and the compressor are operated, while the blower, the compressor, the introduction mode, and the blowing mode are automatically set depending on a target air outlet temperature. The pre-air conditioning control unit executes the pre-blowing operation mode before execution of the pre-air conditioning operation mode, and then starts the execution of the pre-air conditioning operation mode based on at least one of a difference between an inside-air temperature of the vehicle and an outside-air temperature of the vehicle and a rate of change of the difference when executing a pre-air conditioning.

### CROSS REFERENCE TO RELATED APPLICATION

The application is based on a Japanese Patent Application No. 2014-256566 filed on Dec. 18, 2014, the contents of which are incorporated herein by reference in its entirety.

### FIELD OF THE INVENTION

The present disclosure relates to an air conditioner for a vehicle capable of performing pre-air conditioning that involves starting air-conditioning of a vehicle interior before an occupant gets into the vehicle.

### BACKGROUND ART

An air conditioner for a vehicle that enables the pre-air conditioning is known in the related art, for example, as described in Patent Document 1. The vehicle air conditioner described in Patent Document 1 has a pre-air conditioning operation mode and a pre-blowing operation mode as its operation modes for the pre-air conditioning. In the pre-air conditioning operation mode, a blower and a compressor are operated. In the pre-blowing operation mode, the blower is operated while prohibiting the operation of the compressor, and further an inside/outside air switch is brought into an outside air mode. An operation-mode determination portion is designed to determine the operation mode of the air conditioner to be the pre-air conditioning operation mode when an air-conditioning-use permissible power is more than a predetermined reference power. The air-conditioning-use permissible power is part of a usable power throughout the entire vehicle that is permitted for use in the air-conditioning of the vehicle interior. In contrast, the operation-mode determination portion is designed to determine the operation mode to be the pre-blowing operation mode when the air-conditioning-use permissible power is equal to or less than the reference power.

Patent Document 1 describes that in the vehicle air conditioner, the conditions for switching between the pre-air conditioning and pre-blowing operation modes may be based on a difference between the vehicle interior temperature and the outside-air temperature, instead of based on the air-conditioning-use permissible power described above.

In the vehicle air conditioner described in Patent Document 1, a blowing mode (air outlet mode) taken when performing the pre-blowing operation mode and the volume of air blown by the blower are determined based on a target air outlet temperature (TAO) calculated by air-conditioning environmental conditions.

### RELATED ART DOCUMENT

### Patent Document

Patent Document 1: Japanese Unexamined Patent Application Publication No. 2011-88600

### SUMMARY OF INVENTION

Meanwhile, based on studies by the inventors of the present application, the vehicle air conditioner described in Patent Document 1 determines the blowing mode taken when performing the pre-blowing operation mode based on the target air outlet temperature TAO, and thus the determined blowing mode is mainly a face mode, for example, in summer. In contrast, a normal air conditioner for a vehicle includes a foot air outlet as the air outlet, in addition to a face air outlet. In this way, the use of a plurality of air outlets to blow the air is effective for ventilation of the vehicle interior.

Although the volume of air blown by the blower is also determined based on the target air outlet temperature TAO, the maximum air volume is not necessarily set in the pre-blowing operation mode, depending on the target air outlet temperature TAO.

Accordingly, in the vehicle air conditioner described in Patent Document 1, there is a possibility that ventilation is not carried out using a sufficient ventilation capacity in the pre-blowing operation mode.

The present disclosure has been made in view of the foregoing matter, and it is an object of the present disclosure to provide an air conditioner for a vehicle that is capable of switching between a pre-air conditioning operation mode and a pre-blowing operation mode and improving the efficiency of the ventilation in the pre-blowing operation mode.

An air conditioner for a vehicle is capable of executing pre-air conditioning in which air-conditioning of a vehicle interior is started before an occupant gets into the vehicle. The air conditioner for a vehicle includes: a blower that blows air into the vehicle interior by being supplied with power; a vapor compression refrigeration cycle including a compressor that compresses and discharges a refrigerant by being supplied with power, the refrigeration cycle being adapted to adjust a temperature of the air blown by the blower; and a pre-air conditioning control unit that controls an operation mode of the air conditioner when executing the pre-air conditioning. The pre-air conditioning control unit is capable of setting a pre-blowing operation mode and a pre-air conditioning operation mode as the operation mode. The pre-blowing operation mode is configured in which the blower is operated with an operation of the compressor prohibited, while an introduction mode of the air is set at an outside-air introduction mode with an output from the blower maximized, and further a blowing mode into the vehicle interior is set at a face-foot mode to enable the air to be blown out of both a face air outlet and a foot air outlet. Furthermore, the pre-air conditioning operation mode is configured in which the blower and the compressor are operated, while respective conditions for the blower, the compressor, the introduction mode, and the blowing mode are automatically set depending on a target air outlet temperature calculated based on an air-conditioning environmental condition in the vehicle. In addition, the pre-air conditioning control unit executes the pre-blowing operation mode before execution of the pre-air conditioning operation mode, and then starts the execution of the pre-air conditioning operation mode based on at least one of a difference between an inside-air temperature of the vehicle interior and an outside-air temperature outside the vehicle and a rate of change of the difference.

Such an air conditioner for a vehicle performs the pre-blowing operation mode before the execution of the pre-air conditioning operation mode when executing the pre-air conditioning. Thus, the air within the vehicle interior is discharged (ventilated) to the outside of the vehicle in advance, so that the temperature of the vehicle interior can be reduced more quickly in summer without using power for operating the compressor. Then, the pre-air conditioning operation mode is started based on at least one of the difference between the inside-air temperature and the outside-air temperature and a rate of change of the difference. Thus, the pre-air conditioning can be effectively performed by the pre-air conditioning operation mode under automatic control. Accordingly, the effective pre-air conditioning can be performed while achieving the power saving.

Furthermore, in the pre-blowing operation mode, the output from the blower is maximized with the outside-air introduction mode set, and the blowing mode is brought into a face-foot mode, so that the air in the vehicle interior can be effectively discharged to the outside of the vehicle at an initial stage of ventilation, thus enhancing the ventilation effect.

### BRIEF DESCRIPTION OF DRAWINGS

FIG. 1 is an explanatory diagram showing the basic structure of a vehicle air conditioner;

FIG. 2 is a block diagram showing the vehicle air conditioner in a first embodiment of the present disclosure;

FIG. 3 is a flowchart of the contents of control in pre-air conditioning;

FIG. 4 is a diagram showing an integral power consumption and an interior temperature in the pre-air conditioning; and

FIG. 5 is a block diagram showing the vehicle air conditioner in a second embodiment of the present disclosure;

### DESCRIPTION OF EMBODIMENTS

In the following, a plurality of embodiments for carrying out the present disclosure will be described with reference to the accompanying drawings. In each embodiment, parts corresponding to the contents described in the previous embodiments are given by the same reference characters and thus some redundant descriptions will be omitted. When only a part of the structure is explained in each embodiment, other parts of the structure can be understood by applying other previous embodiments thereto. Not only a combination of parts in the respective embodiments that are clearly described to be capable of being specifically combined, but also the embodiments can be partly combined together as long as the combination is not problematic, unless otherwise specified.

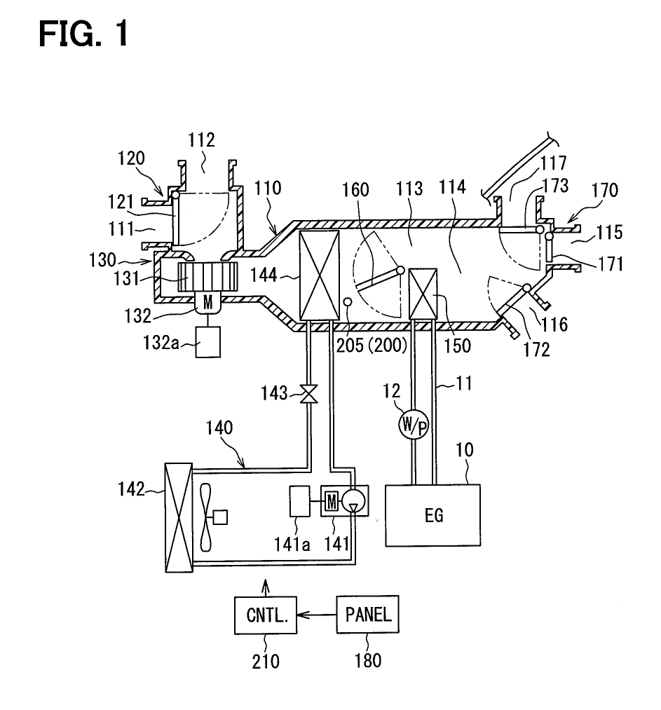

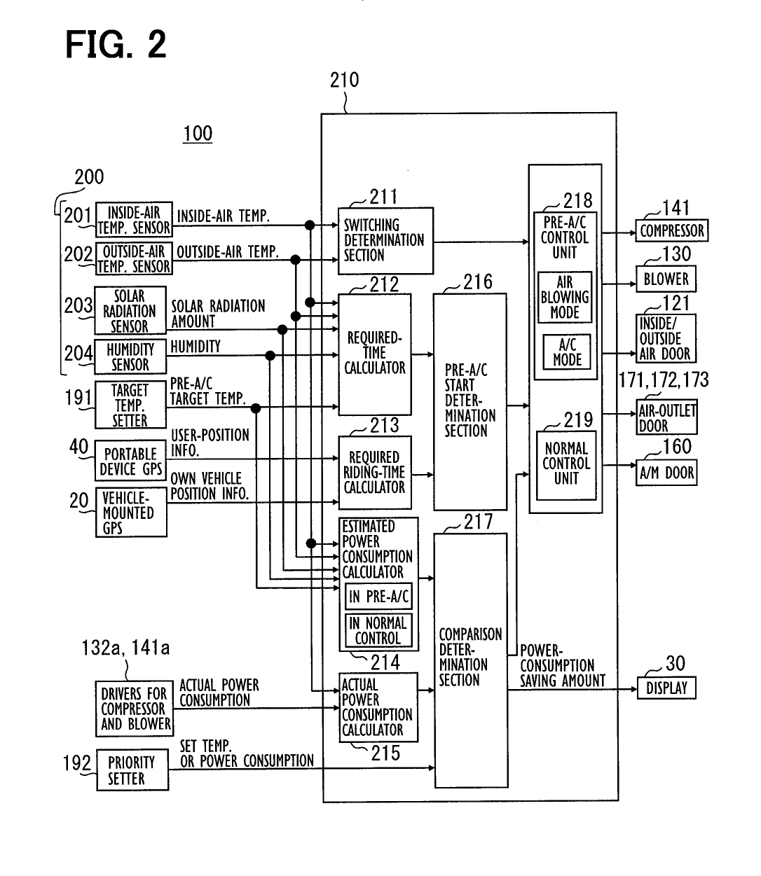

FIGS. 1 to 4 illustrate a vehicle air conditioner (hereinafter referred to as an air conditioner) 100 in a first embodiment. The air conditioner 100 is a device that performs air-conditioning of a vehicle interior. Air conditioning of the vehicle interior includes pre-air conditioning that is started before an occupant gets into the vehicle and normal occupant-riding air-conditioning that is performed after the occupant gets into the vehicle. In this embodiment, the pre-air conditioning is performed to ventilate and cool the vehicle interior before an occupant gets into the vehicle, particularly, the vehicle left in the hot sun in summer.

First of all, the structure of the vehicle associated with the air conditioner 100 will be briefly described.

The vehicle is, for example, a hybrid automobile that includes an engine (EG) 10 and a traveling motor that serve as a traveling drive source. As shown in FIG. 1, the vehicle engine 10 is provided with a coolant circuit 11 for engine cooling. The coolant circuit 11 is provided with a water pump 12 that allows a coolant to circulate between the engine 10 and a heater core 150 to be described later.

The vehicle is equipped with a vehicle-mounted Global Positioning System (GPS) device 20 that receives a radio wave transmitted from an artificial satellite, detects an own vehicle position on a map based on the radio-wave information, and for example, displays the own vehicle position on the map or guides a route to a destination. In this embodiment, the information on the own vehicle position detected by the vehicle-mounted GPS device 20 is used to control the pre-air conditioning of this embodiment, and then output to a required riding-time calculator 213 of a control unit (CNTL.) 210 to be described later.

The vehicle is also provided with a display 30 (for example, a combination meter) that displays various vehicle information. Examples of various vehicle information include a vehicle speed, an engine revolution speed, an engine coolant temperature, a remaining amount of fuel, a gear shift position, an accumulated mileage, fuel efficiency, a cruising distance, etc., and even more, attentions and warnings in various emergencies, and the like. In this embodiment, the display 30 is provided with a display portion that displays thereon an evaluation rating (power-consumption saving amount) on the amount of consumed power when performing the pre-air conditioning. The display portion displays, for example, a bar graph, or a motif of a tree (or leaves) imaging ecology. As the evaluation rating (power-consumption saving amount) is higher, an area within the display portion lit in green is increased.

Suppose that the occupant carries a portable device 40, typified by a cellular phone, such as a smartphone. The portable device 40 is capable of detecting the position of the occupant on a map, like the above-mentioned vehicle-mounted GPS device 20. In this embodiment, information on the occupant position detected by the portable device 40 is used to control the pre-air conditioning of this embodiment, and then output to the required riding-time calculator 213 of the control unit 210 to be described later.

The occupant can use the portable device 40 to make a mode setting of whether the pre-air conditioning is performed or not. A pre-air conditioning execution mode is set to enable the control of the pre-air conditioning (to be described in detail below).

Next, the basic structure of the air conditioner 100 will be described.

The air conditioner 100 includes an air-conditioning case 110, an inside/outside air switching portion 120, a blower 130, a refrigeration cycle 140, the heater core 150, an air mix door 160, an air-outlet switching portion 170, an air-conditioner operation panel (PANEL) 180, a target temperature setter 191, a priority setter 192, a sensor group 200, and the control unit 210.

The air-conditioning case 110 is a case (duct) that has a flow path for allowing air-conditioning air to circulate therethrough. The air-conditioning case 110 is disposed at the front side (within an instrument panel) of the vehicle interior. The most upstream side (windward side) of the air-conditioning case 110 configures the inside/outside air switching portion 120. The inside/outside air switching portion 120 includes an inside-air introduction port 111 for taking in the vehicle interior air (hereinafter referred to as an inside air) and an outside-air introduction port 112 for taking in the vehicle exterior air (hereinafter referred to as an outside air). The inside-air introduction port 111 is opened toward the vehicle interior, while the outside-air introduction port 112 is opened toward the outside of the vehicle.

In the middle portion of an air flow in the air-conditioning case 110, a bypass passage 113 is provided for allowing cool air (cold air) cooled by an evaporator 144 to circulate therethrough while bypassing the heater core 150. In the air-conditioning case 110, an air-mixing portion 114 is provided on the downstream side of the bypass passage 113 and the heater core 150 so as to mix the cold air passing through the bypass passage 113 with heated air (warm air) passing through the heater core 150.

The most downstream side (leeward side) of the air-conditioning case 110 configures the air-outlet switching portion 170. The air-outlet switching portion 170 includes a face air outlet 115, a foot air outlet 116, and a defroster air outlet 117. The respective air outlets 115 to 117 are air outlets positioned on the downstream side of the air-mixing portion 114. The face air outlet 115 is an air outlet through which the conditioned air, mainly the cold air is blown out toward the occupant's head and chest (upper body). The foot air outlet 116 is an air outlet through which the conditioned air, mainly the warm air is blown out toward the occupant's feet (lower body). The defroster air outlet 117 is an air outlet through which the conditioned air, mainly the cold air is blown toward the windshield of the vehicle.

In the inside/outside air switching portion 120, an inside/outside air switching door 121 is disposed for the respective introduction ports 111 and 112. The inside/outside air switching door 121 is a door that rotates to open and close the respective introduction ports 111 and 112. The inside/outside air switching door 121 opens one or both of the introduction ports 111 and 112, thereby switching an introduction mode into an inside-air circulation mode, an inside-air circulation and outside-air introduction mode, an outside-air introduction mode, or the like. The inside/outside air switching door 121 is controlled by the control unit 210 (a pre-air conditioning control unit 218, and a normal control unit 219).

The blower 130 is disposed on the downstream side of the inside/outside air switching portion 120. The blower 130 includes a centrifugal fan 131 that is rotatably accommodated in a scroll case integrally formed with the air-conditioning case 110, and a blower motor 132 rotatably driving the centrifugal fan 131. The blower 130 has a driver 132a that adjusts the number of revolutions of the blower motor 132 steplessly, for example, by duty control of the power supplied to the blower motor 132. The driver 132a is controlled by the control unit 210 (218, 219), whereby the blower air volume (rotational velocity of the centrifugal fan 131) is controlled based on a blower terminal voltage (hereinafter referred to as a blower voltage) applied to the blower motor 132.

The refrigeration cycle 140 is a vapor compression thermal cycle that cools and dehumidifies the air-conditioning air, and is configured by annularly connecting a compressor 141, a condenser 142, an expansion valve 143, the evaporator 144, and the like by refrigerant pipes.

The compressor 141 is a fluid machine that compresses and discharges a refrigerant to circulate the refrigerant through the refrigeration cycle 140. The compressor 141 in use is, for example, a motor-driven (electric) compressor. The operation (rotational speed) of the motor is controlled by power supplied thereto from the driver 141a. Furthermore, the operation of the driver 141a is controlled by the control unit 210 (218, 219), whereby the discharge amount of the refrigerant in the compressor 141 is adjusted totally.

The condenser 142 is a heat exchanger that cools the high-temperature and high-pressure refrigerant discharged from the compressor 141, thereby condensing and liquefying the refrigerant. The expansion valve 143 is a decompression device that decompresses the refrigerant flowing out of the condenser 142 into a low-temperature and low-pressure refrigerant.

The evaporator 144 is disposed on a low-pressure side of the refrigeration cycle 140. The evaporator 144 is a cooling heat exchanger (cooler) that cools and dehumidifies the air-conditioning air passing therethrough by the low-temperature and low-pressure refrigerant flowing out of the expansion valve 143. The evaporator 144 is disposed on the downstream side of the blower 130 to cover the entire surface of an air passage in the air-conditioning case 110.

The heater core 150 is a heating heat exchanger (heater) that heats the air-conditioning air by using a coolant (warm water) circulating through the coolant circuit 11 of the engine 10 as a heat source for air-heating. The heater core 150 is disposed on the downstream side of the evaporator 144 to partly cover the air passage in the air-conditioning case 110. The heater core 150 reheats the cold air cooled by the evaporator 144. A heating capacity of the heater core 150 itself is proportional to the coolant temperature, so that the heating capacity becomes higher as the coolant temperature is increased. Note that the heater core 150 (heater) in use may be, for example, not only a device that uses the above-mentioned coolant as the heat source, but also an electric heater or the like that uses electric power as the heat source.

The air mix door 160 is an adjustment door rotatably provided on the upstream side of the heater core 150. The air mix door 160 adjusts the ratio of the flow rate of the cold air passing through the bypass passage 113 without being heated to that of the warm air heated while passing through the heater core 150 in the air cooled by the evaporator 144 in accordance with a stopped position (opening degree SW) of the rotated air mix door itself. The cold air and the warm air, whose flow rate ratio is adjusted, are mixed in the air-mixing portion 114 into a warm conditioned air, which is blown out into the vehicle interior. The opening degree SW of the air mix door 160 is controlled to be between an opening degree SW=0% (air cooling 100%) to completely close the entire surface of the heater core 150 and an opening degree SW=100% (air heating 100%) to fully open the entire surface of the heater core 150, while completely closing the bypass passage 113 side. The opening degree SW of the air mix door 160 is controlled by the control unit 210 (218, 219).

In the air-outlet switching portion 170, a face door 171, a foot door 172, and a defroster door 173 are provided at the air outlets 115, 116, and 117, respectively. The respective doors 171 to 173 are doors that rotate to open and close the respective air outlets 115 to 117.

The face door 171 among the respective doors 171 to 173 is opened to form the face mode as the blowing mode in which the conditioned air is blown toward the occupant's head and chest (upper body). The foot door 172 is opened to form the foot mode as the blowing mode in which the conditioned air is blown toward the occupant's feet (lower body). The defroster door 173 is opened to form the defroster mode as the blowing mode in which the conditioned air is blown toward the windshield. The respective doors 171 to 173 are controlled to be opened and closed by the control unit 210 (218, 219) as described above. In a face-foot mode, air can be blown from both the face air outlet 115 and the foot air outlet 116.

The air-conditioner operation panel 180 is a panel provided with various switches for operating the respective components 121, 130, 141, 160, and 171 to 173 of the air conditioner 100 based on the occupant's desired control conditions. The air-conditioner operation panel 180 corresponds to an input portion in the present disclosure.

Various switches on the air-conditioner operation panel 180 include an air-conditioner switch, an introduction-inlet selector switch, a temperature setting switch, an air-volume selector switch, and an air-outlet selector switch. The air-conditioner switch is to command the start-up and stopping of the refrigeration cycle 140 (compressor 141). The introduction-inlet selector switch is to switch the introduction mode (inside/outside air switching door 121). The temperature setting switch is to set the temperature of the vehicle interior to a desired temperature (preset temperature Tset). The air-volume selector switch is to change the blower air volume of the blower 130. The air-outlet selector switch is to switch the blowing mode (opening degrees of the respective doors 171 to 173). A switching signal input from each of the switches by the occupant is output to the control unit 210.

The target temperature setter 191 is a setting portion that allows the occupant to set the target temperature in the pre-air conditioning (hereinafter referred to as a pre-air conditioning target temperature Tp). The target temperature setter 191 is installed, for example, in the vicinity of the air-conditioner operation panel 180, or within a region of the air-conditioner operation panel 180. A setting signal of the pre-air conditioning target temperature Tp set by the target temperature setter 191 is output to a required-time calculator 212 of the control unit 210.

The priority setter 192 is a setter that sets whether priority is given to either the continuation or halt of the pre-air conditioning control, when the consumed power in the pre-air conditioning control is higher than a predetermined condition, as described later. In the continuation of the pre-air conditioning control, the pre-air conditioning target temperature Tp set by the occupant himself/herself is changed. The priority setter 192 is installed, for example, in the portable device 40, in the vicinity of air-conditioner operation panel 180, or within a region of the air-conditioner operation panel 180. A setting signal of the priority set by the priority setter 192 is output to a comparison determination section 217 of the control unit 210.

The group 200 of various sensors includes an inside-air temperature sensor 201, an outside-air temperature sensor 202, a solar radiation sensor 203, a humidity sensor 204, and a cold-air temperature sensor 205. The inside-air temperature sensor 201 detects the air temperature in the vehicle compartment (inside-air temperature Tr). The outside-air temperature sensor 202 detects the temperature of air outside the vehicle compartment (outside-air temperature Tam). The solar radiation sensor 203 detects the amount of solar radiation Ts received by the vehicle interior. The humidity sensor 204 detects the humidity of the vehicle interior. The cold-air temperature sensor 205 detects the temperature TE of cold air cooled while passing through the evaporator 144.

A sensor signal detected by the inside-air temperature sensor 201 is output to a switching determination section 211, the required-time calculator 212, an estimated power consumption calculator 214, and an actual power consumption calculator 215 in the control unit 210.

A sensor signal detected by the outside-air temperature sensor 202 is output to the switching determination section 211, the required-time calculator 212, and the estimated power consumption calculator 214 in the control unit 210.

Sensor signals detected by the solar radiation sensor 203 and the humidity sensor 204 are output to the required-time calculator 212 and the estimated power consumption calculator 214 in the control unit 210.

A sensor signal detected by the cold-air temperature sensor 205 is output to the control unit 210.

The control unit 210 controls the operations (of pre-air conditioning and occupant-riding air-conditioning) of the respective components 121, 130, 141, 160, and 171 to 173 (as will be described later in detail). The control unit 210 is a microcomputer including a CPU, an ROM, an RAM, etc., and is mounted on the vehicle together with the main body of the air conditioner 100. The control unit 210 includes the switching determination section 211, the required-time calculator 212, the required riding-time calculator 213, the estimated power consumption calculator 214, the actual power consumption calculator 215, a pre-air conditioning start determination section 216, the comparison determination section 217, the pre-air conditioning control unit 218, and the normal control unit 219.

The above-mentioned respective sections 211 to 219 may be formed as individual circuits, or may be formed by a software on the microcomputer.

The switching determination section 211 (hereinafter referred to as the “determination section 211”) determines the switching (timing of switching) from a pre-blowing operation mode using mainly the blower 130 to the pre-air conditioning operation mode using the blower 130 and the compressor 141, based on at least one of a difference between the inside-air temperature and the outside-air temperature and a rate of change of the difference when intending to perform the pre-air conditioning. The result determined by the determination section 211 is output to the control units 218 and 219.

The required-time calculator 212 (hereinafter referred to as the “calculator 212”) is a calculator that estimates and calculates a period of time required for the vehicle interior temperature to reach a pre-air conditioning target temperature Tp after the start-up of the pre-air conditioning (hereinafter referred to as a “required pre-air conditioning time TPRE”) in the pre-air conditioning.

The result estimated and calculated by the calculator 212 is output to the pre-air conditioning start determination section 216.

Suppose that an occupant carrying the portable device 40 walks toward a vehicle for use. The required riding-time calculator 213 (hereinafter referred to as the “calculator 213”) is a calculator that estimates and calculates a period of time required for occupant-position information detected by the portable device 40 to indicate the arrival at the vehicle after entry into an area receivable by the control unit 210 (hereinafter referred to as a “required riding time TRIDE”). The result estimated and calculated by the calculator 213 is output to the pre-air conditioning start determination section 216.

The estimated power consumption calculator 214 (hereinafter referred to as the “calculator 214”) is a calculator that estimates and calculates powers required for pre-air conditioning based on the air-conditioning environmental conditions in the vehicle. Specifically, the calculator 214 estimates and calculates a power required to perform the pre-air conditioning (hereinafter referred to as an “estimated pre-air conditioning power consumption Pp”). The calculator 214 also estimates and calculates a power required if the pre-air conditioning is performed under control conditions for execution of the normal occupant-riding air-conditioning (in the normal pre-air conditioning operation mode of the present disclosure) (hereinafter referred to as an “estimated normal-control power consumption Pn). The result estimated and calculated by the calculator 214 is output to the comparison determination section 217.

The actual power consumption calculator 215 (hereinafter referred to as the “calculator 215”) is a calculator that calculates power (actual power consumption Pr) actually consumed when performing the pre-air conditioning. The result calculated by the calculator 215 is output to the comparison determination section 217.

The pre-air conditioning start determination section 216 (hereinafter referred to as a “determination section 216”) is a determination section that determines the start of the pre-air conditioning based on the results from the calculators 212 and 213. The result determined by the determination section 216 is output to the control units 218 and 219.

Based on the results from the calculators 214 and 215, the comparison determination section 217 is a determination section that determines the control units 218 and 219 to change the pre-air conditioning target temperature Tp in the pre-air conditioning or to halt the pre-air conditioning, or alternatively that causes the display 30 to show the power-consumption saving amount.

The pre-air conditioning control unit 218 is a control unit that executes the pre-air conditioning by controlling the respective components 121, 130, 141, 160, and 171 to 173, based on the results from the determination sections 211 and 216 and the comparison determination section 217.

The normal control unit 219 is a control unit that controls the respective components 121, 130, 141, 160, and 171 to 173, based on the results from the determination sections 211 and 216 and the comparison determination section 217, thereby executing the occupant-riding air conditioning.

The structure of the air conditioner 100 has been described above. Next, the operation of the air conditioner 100 will be described.

### 1. Occupant-Riding Air-Conditioning Control

The occupant-riding air-conditioning is a normal air-conditioning performed after an occupant gets into a vehicle, and is controlled by the normal control unit 219 in the control unit 210. The normal control unit 219 calculates a target air outlet temperature TAO, which is a target for the air-conditioning air, based on the inside-air temperature Tr obtained from the inside-air temperature sensor 201, the outside-air temperature Tam obtained from the outside-air temperature sensor 202, the solar radiation amount Ts obtained from the solar radiation sensor 203, and the preset temperature Tset obtained from a temperature setting switch on the air-conditioner operation panel 180. The target air outlet temperature TAO is calculated by the following formula F1:

TAO=Kset·Tset−Kr·Tr−Kam·Tam−Ks·Ts+C . . . F1 (Formula 1)

where Kset, Kr, Kam, and Ks are control gains, and C is a constant for correction.

The normal control unit 219 calculates a target cold-air temperature TEO, which is a target for the cold air on the downstream side of the evaporator 144, based on the target air outlet temperature TAO.

The normal control unit 219 determines an introduction mode from a map pre-stored therein based on the target air outlet temperature TAO, and controls a rotation position of the inside/outside air switching door 121 to bring one or both of the introduction ports 111 and 112 into an opened state in such a manner as to achieve the determined introduction mode.

The normal control unit 219 determines a blower air volume (blower voltage) of the blower 130 from a map pre-stored therein based on the target air outlet temperature TAO, and also controls the rotational speed of the blower motor 132 by the driver 132a in such a manner as to achieve the determined blower air volume.

Furthermore, the normal control unit 219 controls the amount of discharge from the compressor 141 by a driver 141a such that a cold-air temperature TE (cold-air temperature sensor 205) on the downstream side of the evaporator 144 becomes the target cold-air temperature TEO.

The normal control unit 219 calculates a target opening degree of the air mix door 160 from a calculation formula pre-stored therein such that a blown-air temperature becomes the target air outlet temperature TAO, and controls a rotation position (opening degree SW) of the air mix door 160 to achieve the target opening degree calculated. That is, the rotation position of the air mix door 160 is controlled to adjust the ratio of the flow rate of the warm air passing through the heater core 150 to the cold air passing through the bypass passage 113 in the cooled air by the evaporator 144, thereby controlling or adjusting the temperature of blown air.

The normal control unit 219 determines the blowing mode from a map pre-stored therein based on the target air outlet temperature TAO, and controls a rotation position of each of the doors 171 to 173 in the air-outlet switching portion 170 to open one of the air outlets 115 to 117 in such a manner as to achieve the determined blowing mode.

When a control condition is input by an occupant from any of various switches on the air-conditioner operation panel 180, the normal control unit 219 switches the operation states of the respective components 121, 130, 141, 160, and 171 to 173 in the air conditioner 100 to achieve the control condition selected by the input.

### 2. Pre-Air Conditioning Control

The pre-air conditioning is air-conditioning that is started before an occupant gets into a vehicle, especially in summer, and is controlled by the control unit 210 (211 to 218). The pre-air conditioning is classified into a pre-blowing operation mode and a pre-air conditioning operation mode.

The pre-blowing operation mode is an operation mode that involves operating the blower 130 with the operation of the compressor 141 prohibited, while setting an introduction mode of an inside or outside air to the outside-air introduction mode with an output from the blower 130 maximized, and further setting the blowing mode into the vehicle interior to the face-foot mode.

The pre-air conditioning operation mode is an operation mode that involves operating the blower 130 and the compressor 141, and at the same time automatically setting respective conditions for the blower 130, the compressor 141, the introduction mode, and the blowing mode in accordance with the target air outlet temperature TAO calculated based on the air-conditioning environmental conditions in the vehicle.

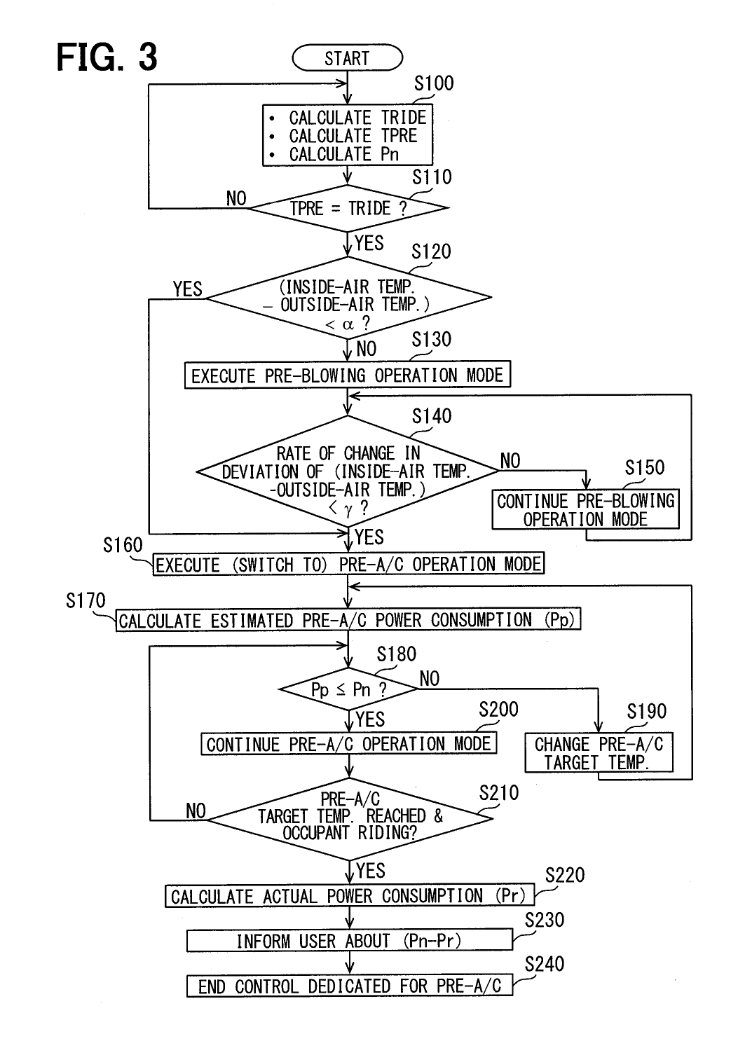

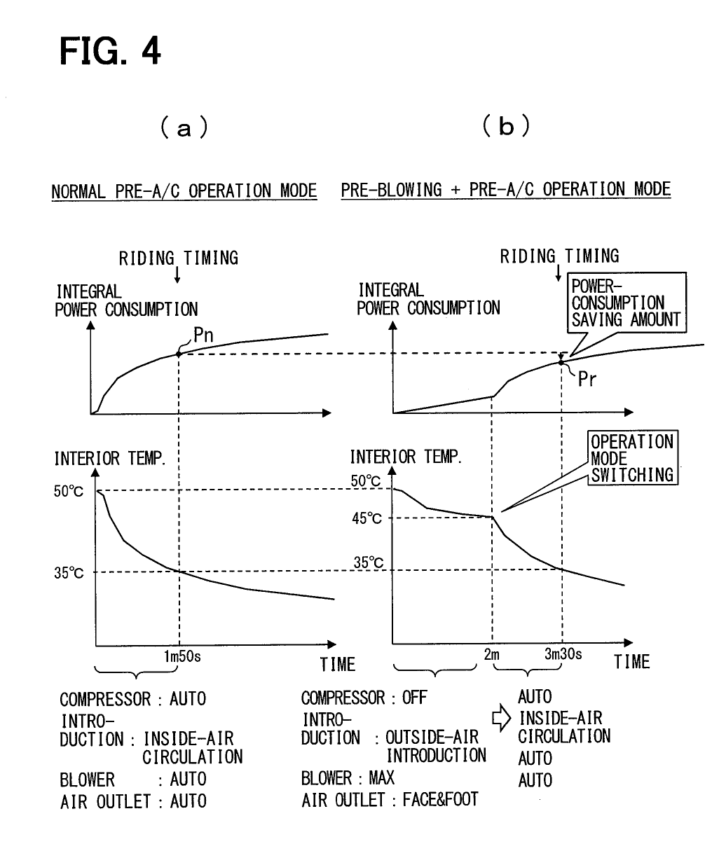

A control procedure of the pre-air conditioning will be described below with reference to a flowchart in FIG. 3 in addition to a time chart in FIG. 4.

When performing the pre-air conditioning control, an occupant sets a pre-air conditioning execution mode by the portable device 40 to register the setting in the pre-air conditioning control unit 218 in advance. The occupant sets a pre-air conditioning target temperature Tp (e.g., 35° C.) by the target temperature setter 191 beforehand. Furthermore, the occupant sets in advance, by use of the priority setter 192, which priority is given to either the change of the pre-air conditioning target temperature Tp or the halt of the pre-air conditioning, when the power consumption in the pre-air conditioning is higher than a predetermined condition. Hereinafter, by way of example, the occupant registers the priority which is to be given to the change of the pre-air conditioning target temperature Tp.

Suppose that an occupant carrying the portable device 40 walks toward a vehicle for use. Referring to the flowchart in FIG. 3, the control is started at the timing when occupant-position information detected by the portable device 40 indicates the entry into an area receivable by the control unit 210 (calculator 213).

First, in step S100, the control unit 210 (calculators 212, 213, and 214) calculates a required riding time TRIDE, a required pre-air conditioning time TPRE, and an estimated normal control power consumption Pn.

The required riding time TRIDE is calculated by the calculator 213 based on the following formula 2.

TRIDE=(occupant's position−own vehicle position)/walking speed (Formula 2)

where the occupant's position is a position of the occupant on a map detected by the portable device 40; and the own vehicle position is a position of the occupant's vehicle (own vehicle) on the map detected by the vehicle-mounted GPS device 20. A difference between both positions is used to calculate a distance between the occupant and the vehicle on the map. The walking speed is, for example, an average walking speed (approximately 4 km/h) of a normal adult.

The required pre-air conditioning time TPRE is calculated by the calculator 212 based on the following formulas 3 to 6.

Thermal load L on the vehicle interior=A+B·t (sec.) (Formula 3)

where A is a heat amount (formula 4) required for the inside-air temperature Tr to reach the pre-air conditioning target temperature Tp; and B is a heat amount (formula 5) required for the inside-air temperature Tr to maintain the pre-air conditioning target temperature Tp after reaching the pre-air conditioning target temperature Tp.

A=S·{K1·(Tr−Tp)+K2·Tam+K3·Ts+K4·Tr+C1}+C2 (Formula 4)

where S is a vehicle interior capacity, and K1 to K4, C1, and C2 are constants.

B=S·(K5·Tp+K6·Tam+K7·Ts+C3)+C4 (Formula 5)

where K5 to K7, C3, and C4 are constants.

TPRE=A/(K−B) (Formula 6)

where K is a maximum cooling capacity.

The estimated normal control power consumption Pn is calculated by the calculator 214, for example, based on a normal control map pre-stored.

In the normal control map, with regard to the occupant-riding air-conditioning (normal air-conditioning), the inside-air temperature Tr, the outside-air temperature Tam, the solar radiation amount Ts, the preset temperature Tset, and the humidity of the vehicle interior are previously linked to the required power consumptions for the blower 130 and compressor 141. Subsequently, the estimated normal control power consumption Pn is calculated from signal values obtained by the respective sensors 201 to 204.

Then, in step S110, the control unit 210 determines whether or not the required riding time TRIDE calculated in step S100 is equal to the required pre-air conditioning time TPRE. The step S110 is to determine an optimum timing of starting the pre-air conditioning in sequent step S130.

That is, the required riding time TRIDE is gradually decreased as the occupant gets closer to the vehicle. When the required riding time TRIDE is larger than the required pre-air conditioning time TPRE, the pre-air conditioning is continued until the occupant reaches the vehicle after completion of the pre-air conditioning, resulting in extra power consumption due to such pre-air conditioning. Conversely, when the required riding time TRIDE is smaller than the required pre-air conditioning time TPRE, the pre-air conditioning is not found to be completed, even when the occupant reaches the vehicle. Accordingly, the air-conditioning control needs the determination of the condition in which the required riding time TRIDE is equal to the required pre-air conditioning time TPRE.

If a negative determination is made in step S110, the operation repeats steps S100 and S110. Thereafter, if an affirmative determination is made in step S110, the operation proceeds to step S120.

During step S120, in the control unit 210, the calculator 212 calculates a difference between the inside-air temperature Tr and the outside-air temperature

Tam, and the determination section 216 determines whether the difference is smaller than a predetermined first determination value a. The first determination value a is a determination value to clearly determine a significant difference between the inside-air temperature Tr and the outside-air temperature Tam, and for example, uses about 5° C. If a negative determination is made in step S120, the inside-air temperature Tr is determined to be higher than the outside-air temperature Tam+a, and then the operation proceeds to step S130. If an affirmative determination is made in step S120, the inside-air temperature Tr is determined to be lower than the outside-air temperature Tam+a, and then the operation proceeds to step S160.

In step S130, the control unit 210 (pre-air conditioning control unit 218) first executes the pre-blowing operation mode before the pre-air conditioning control. That is, the control unit 210 (218) brings the compressor 141 into an off state, operates the blower 130 with the maximum output, while forming the outside-air introduction mode by the inside/outside air switching door 121, and further forms the face-foot mode by the respective doors 171 to 173 in the air-outlet switching portion 170.

The vehicle interior air is effectively discharged to the outside of the vehicle by the operation setting described above, and as illustrated in FIG. 4(b), the initial inside-air temperature Tr (e.g., a level of 50° C.) is decreased to some temperature (e.g., 45° C.).

During step S140, in the control unit 210, the determination section 211 calculates a rate of change of the difference between the inside-air temperature Tr and the outside-air temperature Tam, and determines whether the rate of change of the difference is smaller than a predetermined second determination value g The second determination value g is a determination value to clearly determine whether the change in the difference between the temperatures Tr and Tam, specifically, the decrease in the inside-air temperature Tr barely appears. If a negative determination is made in step S140, the inside-air temperature Tr is continuously decreased, and then in step S150, the pre-blowing operation mode is continued as it is.

However, if the determination is made to be affirmative (Yes) by the determination section 211 in step S140, the control unit 210 (218) determines that the decrease in the inside-air temperature Tr barely appears and switches from the pre-blowing operation mode to the pre-air conditioning operation mode in step S160. That is, the control unit 210 (218) turns on both the blower 130 and the compressor 141 and automatically sets the respective conditions for an output of the blower 130, an output (discharge amount) of the compressor 141, the introduction mode, and the blowing mode, based on the target air outlet temperature TAO.

Thus, in this embodiment, the control unit 210 (218) is adapted to first execute the pre-blowing operation mode before the execution of the pre-air conditioning operation mode. When the difference between the temperatures Tr and Tam is determined to be smaller than the first determination value a in step S120, the air conditioner is shifted to the pre-air conditioning operation mode in step S160. Thus, depending on a difference between the temperatures Tr and Tam, the pre-blowing operation mode is omitted in some cases. That is, the control includes a case in which the pre-blowing operation mode is executed before the execution of the pre-air conditioning operation mode.

In this embodiment, the control unit 210 (218) starts the execution of the pre-air conditioning operation mode based on at least one (here, both) of the difference between the temperatures Tr and Tam and the rate of change of the difference. In other words, the control unit 210 (218) basically determines the timing of starting the execution of the pre-air conditioning operation mode based on at least one (here, both) of the difference between the temperatures Tr and Tam and the rate of change of the difference.

Note that an operation mode other than the pre-blowing operation mode may be included as the operation mode executed before the pre-air conditioning operation mode. An example of this case is an operation mode of temporarily switching to an inside-air mode when air (smell) of the outside of the vehicle becomes worse. Another example is an operation mode of temporarily operating the blower 130 with an intermediate output before starting the operation of the compressor 141, in accordance with the state (refrigerant temperature) of the refrigeration cycle, for the purpose of preventing drastic fluctuations in the state of the refrigeration cycle when starting the pre-air conditioning operation mode.

In step S170, the calculator 214 in the control unit 210 calculates (estimates) an estimated pre-air conditioning power consumption Pp that is required for the entire pre-air conditioning (pre-blowing operation and pre-air conditioning operation) at predetermined time intervals (e.g., every several seconds) after the instant of switching from the pre-blowing operation mode to the pre-air conditioning operation mode.

Then, in step S180, the comparison determination section 217 in the control unit 210 determines whether the estimated pre-air conditioning power consumption Pp is equal to or less than the estimated normal control power consumption Pn calculated in step S100.

If a negative determination is made in step S180, this means that the estimated pre-air conditioning power consumption Pp is larger than the estimated normal control power consumption Pn, failing to save power. Thus, the control unit 210 proceeds to step S190, in which the pre-air conditioning target temperature Tp is changed. This is processed in accordance with the priority previously set by the occupant using the priority setter 192. The pre-air conditioning target temperature Tp is changed, for example, such that an initial pre-air conditioning target temperature Tp is increased, for example, by about 2 to 3° C. each time. Then, steps S170 and S180 are repeated.

On the other hand, if an affirmative determination is made in step S180, the estimated pre-air conditioning power consumption Pp is smaller than the estimated normal control power consumption Pn, thereby saving power. Thus, the control unit 210 (218) continues the pre-air conditioning operation mode in step S200.

In step S210, the control unit 210 (218) determines whether or not the inside-air temperature Tr reaches the pre-air conditioning target temperature Tp and further whether or not the occupant rides on the vehicle. If an affirmative determination is made in step S210, the control unit 210 (218) proceeds to step S220. If a negative determination is made, the control unit 210 repeats steps S180 to S210.

In step S220, the calculator 215 in the control unit 210 (218) calculates an actual power consumption Pr (see FIG. 4(b)) actually consumed in the pre-air conditioning. The actual power consumption Pr is calculated from a voltage and a current that are actually applied to each of the blower 130 and the compressor 141 in the pre-air conditioning (pre-blowing operation and pre-air conditioning operation).

During step S230, in the control unit 210, the comparison determination section 217 calculates a difference between the estimated normal control power consumption Pn (see FIG. 4(a)) and the actual power consumption Pr, and the display 30 displays, to the occupant, the difference between these power consumptions obtained when the actual power consumption Pr is smaller than the estimated normal control power consumption Pn, as a saved power consumption (FIG. 4(b)). In the display portion of the display 30, as the power-consumption saving amount is increased, a more area is displayed and lit in green within a bar-graph display portion or an ecology-image display portion. Thereafter, in step S240, the control unit 210 ends the pre-air conditioning control.

As mentioned above, in this embodiment, the vehicle air conditioner includes the pre-air conditioning control unit 218 for performing the pre-air conditioning. The pre-air conditioning control unit 218 first executes the pre-blowing operation mode before the execution of the pre-air conditioning operation mode, and starts the execution of the pre-air conditioning operation mode based on at least one of a difference between the inside-air temperature Tr of the vehicle interior and the outside-air temperature Tam of the outside of the vehicle and a rate of change of the difference.

Thus, in the execution of the pre-air conditioning, before the execution of the pre-air conditioning operation mode, the pre-blowing operation mode is first performed, thereby discharging (ventilating) the air within the vehicle interior to the outside of the vehicle. In this way, the temperature of the vehicle interior can be reduced more quickly in summer without using power for operating the compressor 141. The pre-air conditioning operation mode is started based on at least one of the difference between the inside-air temperature Tr and the outside-air temperature Tam and a rate of change of the difference. Thus, the pre-air conditioning can be effectively performed by execution of the pre-air conditioning operation mode under automatic control based on some inside-air temperatures Tr. Consequently, the effective pre-air conditioning can be performed while achieving the power saving.

Furthermore, in the above-mentioned pre-blowing operation mode, the output from the blower 130 is maximized with the outside-air introduction mode set, and the blowing mode is brought into a face-foot mode, so that the air in the vehicle interior can be effectively discharged to the outside of the vehicle at an initial stage of ventilation, thus enhancing the ventilation effect.

In this embodiment, the vehicle air conditioner further includes the comparison determination section 217. The comparison determination section 217 compares the estimated normal control power consumption Pn with the estimated pre-air conditioning power consumption Pp. Then, the comparison determination section 217 instructs the pre-air conditioning control unit 218 to change the pre-air conditioning target temperature Tp, or to halt the pre-air conditioning, when the estimated pre-air conditioning power consumption Pp is determined to exceed the estimated normal control power consumption Pn.

Thus, the pre-air conditioning is avoided from being continued while the estimated pre-air conditioning power consumption Pp exceeds the estimated normal control power consumption Pn, thereby making it possible to reduce the power consumption in the pre-air conditioning.

The above-mentioned comparison determination section 217 determines to change the pre-air conditioning target temperature Tp or to halt the pre-air conditioning in accordance with the priority previously set by an occupant through the priority setter 192, when the estimated pre-air conditioning power consumption Pp is determined to exceed the estimated normal control power consumption Pn.

Thus, the change of the pre-air conditioning target temperature Tp or the halt of the pre-air conditioning is performed while taking into consideration the occupant's intention, thereby making it possible to reduce occupant's dissatisfaction with the pre-air conditioning.

In this embodiment, the comparison determination section 217 compares the estimated normal control power consumption Pn with the actual power consumption Pr. When the actual power consumption Pr is below the estimated normal control power consumption Pn, the display 30 displays the difference between these power consumptions as a power-consumption saving amount to allow the occupant to recognize the saving amount.

Thus, the power-consumption saving amount is displayed on the display 30, so that the occupant can recognize the execution of the pre-air conditioning with saved power, which can encourage the occupant to positively use the pre-air conditioning next time or later. Furthermore, the pre-air conditioning can provide comfort to the occupant.

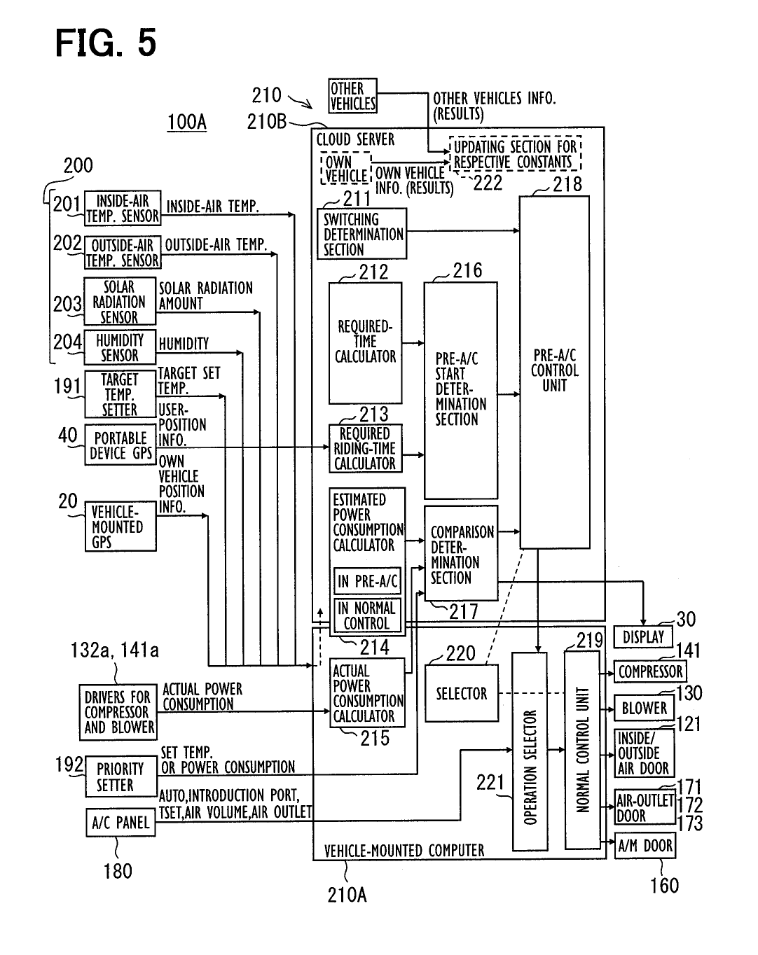

FIG. 5 shows an air conditioner 100A in a second embodiment. The air conditioner 100A in the second embodiment differs from the first embodiment in that the control unit 210 includes a vehicle-mounted computer 210A and a vehicle-external computer 210B. In this embodiment, the vehicle-external computer 210B is a cloud server 210B.

The vehicle-mounted computer 210A is a computer mounted on the vehicle. The vehicle-mounted computer 210A includes the calculator 215, an operation selector 221, the normal control unit 219, and a selector 220.

The cloud server 210B is a computer provided outside the vehicle and capable of communicating with the vehicle-mounted computer 210A. The cloud server 210B includes the determination section 211, the calculators 212 to 214, the determination section 216, the comparison determination section 217, the pre-air conditioning control unit 218, and an updating section 222.

The selector 220 in the vehicle-mounted computer 210A selects the pre-air conditioning control unit 218 as a control unit in the pre-air conditioning control, from the pre-air conditioning control unit 218 and the normal control unit 219. In contrast, the selector 220 selects and switches to the normal control unit 219 as a control unit in the occupant-riding air-conditioning.

The operation selector 221 selects one or more signals from various input signals from the air-conditioner operation panel 180 or various input signals from the pre-air conditioning control unit 218 of the cloud server 210B, and then output the selected signal(s) to the normal control unit 219.

Information items input from the cloud server 210B into the vehicle-mounted computer 210A are set substantially the same as information items regarding control conditions set by the air-conditioner operation panel 180. That is, the information items input from the cloud server 210B into the vehicle-mounted computer 210A include a start/stop command signal for the compressor 141, an introduction-mode switching signal, a preset-temperature signal, an air-volume switching signal, and a blowing-mode switching signal.

The cloud server 2108 stores past information on the own vehicle about its past and past information on other vehicles about their past with regard to control results of the pre-air conditioning. Such other vehicles indicate vehicles other than the own vehicle but of the same model.

The updating section 222 uses the past information on the own vehicle and the past information on other vehicles stored in the cloud server 210B to update at least one condition in a control logic for the pre-air conditioning.

The control logic is, for example, one that is based on its control flowchart explained with reference to FIG. 3. The conditions within the control logic include, for example, a constant in an arithmetic expression for computing various control values, and a determination value in a determination step. In other words, the updating section 222 learns and updates the control logic using the past information on the own vehicle and the past information on other vehicles. The past information on the own vehicle about its past and on other vehicles about their past in use is information about the past pre-air conditioning control provided, especially when preferable control results are obtained.

Note that the detection signals detected by the respective sensors 201 to 204, the pre-air conditioning target temperature Tp set by the target temperature setter 191, and the own-vehicle position signal detected by the vehicle-mounted GPS device 20 are temporarily input to the vehicle-mounted computer 210A, and then output from the vehicle-mounted computer 210A to the respective components 211 to 214 of the cloud server 210B.

In this embodiment, the occupant-riding air-conditioning is executed by the normal control unit 219 configured in the vehicle-mounted computer 210A, while the pre-air conditioning control is performed by the pre-air conditioning control unit 218 configured in the cloud server 210B. The switching of the use between the normal control unit 219 and the pre-air conditioning control unit 218 is performed by the selector 220.

The basics of the control procedures in the occupant-riding air-conditioning and the pre-air conditioning are substantially the same as those described in the above-mentioned first embodiment. Note that in this embodiment, as mentioned above, the updating section 222 updates (learns) at least one condition within the control logic by using the past information on the own vehicle about its past and the past information on other vehicles about their past.

As mentioned above, in this embodiment, the normal control unit 219 is configured in the vehicle-mounted computer 210A, and the pre-air conditioning control unit 218 is configured in the cloud server 210B, whereby either of the control units 218 and 219 is selected by the selector 220.

Thus, during the pre-air conditioning control, the pre-air conditioning can be controlled by using the pre-air conditioning control unit 218 in the cloud server 210B.

In the pre-air conditioning control, the updating section 222 uses the past information on the own vehicle about its past or the past information on other vehicles about their past previously stored in the cloud server 210B to update at least one condition within the control logic for the pre-air conditioning.

Thus, the control logic is updated by utilizing the past information on the own vehicle about its past or the past information on other vehicles about their past, thereby making it possible to improve the conformity (accuracy) of the pre-air conditioning control.

Information items input from the cloud server 210B into the vehicle-mounted computer 210A are set at substantially the same as information items regarding control conditions set by the air-conditioner operation panel 180.

This eliminates the necessity of additionally setting an input section (interface) for inputting the information items from the cloud server 2108 into the vehicle-mounted computer 210A, thereby also using the standard vehicle-mounted computer 210A as the input section.

### Other Embodiments

In the above-mentioned first and second embodiments, the pre-air conditioning control is performed such that the execution of the pre-air conditioning operation mode is started based on both the difference between the inside-air temperature Tr and the outside-air temperature Tam and the rate of change of the difference. However, the present disclosure is not limited thereto, and alternatively, the pre-air conditioning control may use either of them.

As described in the first and second embodiments, when a negative determination is made in step S180, the pre-air conditioning target temperature is changed based on the priority set by the occupant in step S190. If the halt of the pre-air conditioning is previously set as the priority by the occupant, in step S190, the control of halting the pre-air conditioning is executed. Here, the pre-air conditioning control is ended.

In the second embodiment, the information items input from the cloud server 210B into the vehicle-mounted computer 210A are set at substantially the same as information items regarding the control conditions set by the air-conditioner operation panel 180. However, the present disclosure is not limited thereto. That is, an input section (interface) dedicated for the cloud server 210B is provided in the vehicle-mounted computer 210A, so that different information items can be input from the cloud server 210B to the vehicle-mounted computer 210A.

The display 30 uses a combination meter, but is not limited thereto. Alternatively, the display 30 may be a special display device.

The vehicle equipped with the air conditioner 100 or 100A is a hybrid vehicles, but may be an engine vehicle including only an engine as a traveling drive source or an electric vehicle including only a traveling motor.

1. An air conditioner for a vehicle that is capable of executing pre-air conditioning in which air-conditioning of a vehicle interior is started before an occupant gets into the vehicle, the air conditioner comprising:
a blower that blows air into the vehicle interior by being supplied with power;
a vapor compression refrigeration cycle including a compressor that compresses and discharges a refrigerant by being supplied with power, the refrigeration cycle being adapted to adjust a temperature of the air blown by the blower; and
a pre-air conditioning control unit that controls an operation mode of the air conditioner when executing the pre-air conditioning, wherein
the pre-air conditioning control unit is capable of setting a pre-blowing operation mode and a pre-air conditioning operation mode as the operation mode,
the pre-blowing operation mode being configured in which the blower is operated with an operation of the compressor prohibited, while an introduction mode of the air is set at an outside-air introduction mode with an output from the blower maximized, and further a blowing mode into the vehicle interior is set at a face-foot mode to enable the air to be blown out of both a face air outlet and a foot air outlet,
the pre-air conditioning operation mode being configured in which the blower and the compressor are operated, while respective conditions for the blower, the compressor, the introduction mode, and the blowing mode are automatically set depending on a target air outlet temperature calculated based on an air-conditioning environmental condition in the vehicle, and
the pre-air conditioning control unit executes the pre-blowing operation mode before execution of the pre-air conditioning operation mode, and then starts the execution of the pre-air conditioning operation mode based on at least one of a difference between an inside-air temperature of the vehicle interior and an outside-air temperature outside the vehicle and a rate of change of the difference.

2. The air conditioner for a vehicle according to claim 1, further comprising:
a normal control unit that controls normal air-conditioning of the vehicle interior based on the target air outlet temperature while the occupant is riding on the vehicle, wherein a normal pre-air conditioning operation mode is defined as pre-air conditioning executed by the normal control unit based on the normal air-conditioning in execution of the pre-air conditioning; and
a comparison determination section that is provided to compare an estimated normal control power consumption with an estimated pre-air conditioning power consumption, the estimated normal control power consumption being a power estimated to be consumed until a pre-air conditioning target temperature is reached in the normal pre-air conditioning operation mode, the estimated pre-air conditioning power consumption being a power estimated to be consumed until the pre-air conditioning target temperature is reached in the pre-blowing operation mode and the pre-air conditioning operation mode, wherein
the comparison determination section instructs the pre-air conditioning control unit to change the pre-air conditioning target temperature or to halt the pre-air conditioning when the estimated pre-air conditioning power consumption is determined to exceed the estimated normal control power consumption.

3. The air conditioner for a vehicle according to claim 2, further comprising:
a priority setter that allows the occupant to set a priority between the pre-air conditioning target temperature and the estimated pre-air conditioning power consumption, wherein
the comparison determination section determines to change the pre-air conditioning target temperature or to halt the pre-air conditioning depending on the priority set by the priority setter, when the estimated pre-air conditioning power consumption is determined to exceed the estimated normal control power consumption.

4. The air conditioner for a vehicle according to claim 2, further comprising:
a vehicle-mounted computer mounted on the vehicle; and
a vehicle-external computer capable of communicating with the vehicle-mounted computer, wherein
the normal control unit is provided in the vehicle-mounted computer,
the pre-air conditioning control unit is provided in the vehicle-external computer, and
the vehicle-mounted computer includes a selector that selects one of the normal control unit and the pre-air conditioning unit.

5. The air conditioner for a vehicle according to claim 4, wherein
the vehicle-exterior computer stores therein past information of an own vehicle and past information of other vehicles, with regard to control results of the pre-air conditioning, and
the vehicle-exterior computer includes an updating section capable of updating at least one condition within a control logic for the pre-air conditioning, using the past information of the own vehicle or the past information of the other vehicles.

6. The air conditioner for a vehicle according to claim 4, further comprising:
an input section that enables input of a setting of a control condition into the normal control unit by a manual operation of the occupant, wherein
information items input from the vehicle-external computer into the vehicle-mounted computer are substantially the same as information items regarding the control condition set by the input section.

7. The air conditioner for a vehicle according to claim 2, wherein
the comparison determination section compares the estimated normal control power consumption with an actual power consumption actually consumed in the pre-air conditioning executed by the pre-air conditioning control unit until the pre-air conditioning target temperature is reached, and
the air conditioner further includes a display that displays a power-consumption saving amount to the occupant, the power-consumption saving amount being a difference between the actual power consumption and the estimated normal control power consumption when the actual power consumption is determined to be below the estimated normal control power consumption by the comparison determination section.
